(19) United States
(12) Patent Application Publication
(10) Pub. No.: US 2008/0158018 A1
(43) Pub. Date: Jul. 3, 2008

(54) System, Method, and Computer-Readable Medium for Distribution of Point of Interest Location Information in a Mobile Telecommunication Network

(76) Inventor: David A. Lau, Dallas, TX (US)

Correspondence Address: HAYNES AND BOONE, LLP, 901 Main Street, Suite 3100, Dallas, TX, 75202, US

(21) Appl. No.: 11/617,460

(22) Filed: Dec. 28, 2006

(51) Int. Cl. G01C 21/00

(52) U.S. Cl. 340/995.24; 701/209

(57) ABSTRACT

A method and system for user supply of point of interests is provided. User-supplied point of interest information may be maintained in a network storage facility mobile terminal, or other electronic digital storage device. A GPS device or mobile terminal for which location information may be determined may initiate a query of a user-supplied point of interest in conjunction with the location of the mobile terminal. Location or navigation information of the user-supplied point of interest may be retrieved and transmitted to the mobile terminal for display hereby.

### BACKGROUND

The Global Positioning System (GPS) comprises a satellite navigation system that facilitates accurate determination of location including longitude, latitude, and altitude. The GPS system includes a constellation of various satellites that broadcast timing signals by radio. A GPS receiver receives a plurality of the timing signals thereby allowing accurate determination of the GPS receiver's location.

GPS is used as a navigation aid in cars, airplanes, and ships. Personal navigation devices, such as hand-held GPS receivers, may be used in a variety of outdoor activities. GPS receivers are often integrated with personal digital assistants (PDAs), cell phones, car computers, or vehicle tracking systems.

Supplementary information services may be provided in conjunction with GPS positioning information to provide a user with location or directional information of particular points of interests. For example, some navigation services may provide location information related to specific travel needs or interests, such as information regarding locations/directions to service stations, restaurants, or other locations of interest.

A map database may be used in conjunction with a GPS system to graphically depict the location of the GPS receiver on a road. Street names and numbers as well as points of interest (POIs), such as restaurants, automated teller machines (ATMs), service stations, and the like, may be encoded as geographic coordinates so that a user may find a desired destination by street address. POI information may be provided by a location-based service offered in conjunction with the GPS service or as a supplementary service that operates in conjunction with a GPS service. Disadvantageously, POI information available for location and display on a GPS receiver is limited by the content provided by the location-based service.

In other systems, location information may be provided by a terrestrial-based network or system. For example, terrestrial based transceivers may determine a location of a device by triangulation algorithms or other mechanisms, such as received power mechanisms. The location may then be transmitted from the terrestrial system to the mobile terminal or other device via, for example, a cellular or other wireless network. The location may be conveyed to a navigation service via an application programming interface (API) or other suitable mechanism that in turn may provide navigational services to the mobile terminal. However, such systems generally exhibit deficiencies similar to those described above with regard to GPS services.

### BRIEF DESCRIPTION OF THE DRAWINGS

Aspects of the present disclosure are best understood from the following detailed description when read with the accompanying figures, in which:

FIG. 1 is a diagrammatic representation of a network system in which a mobile terminal may be deployed for obtaining position and directional information in accordance with embodiments; need to add to FIG. 1 user database 200 and application server 210 connected to Internet.

FIG. 2 is an exemplary diagrammatic representation of a point of interest server that may be configured for provisioning of user-specified point of interest information in accordance with embodiments disclosed herein;

FIG. 3 is a diagrammatic representation of an exemplary embodiment of a client data processing system depicted in FIG. 1;

FIG. 4 is a diagrammatic representation of a map data structure depicting three exemplary map records implemented in accordance with an embodiment;

FIG. 5A is a simplified block diagram of an exemplary mobile terminal in which embodiments may be implemented;

FIG. 5B is a diagrammatic representation of a software configuration of a mobile terminal adapted to request and receive location and navigation information in the system depicted in FIG. 1 in accordance with an embodiment;

FIG. 6 is a diagrammatic representation of an embodiment of a web page that may be provided by a point of interest server to a client thereof for submission of user-specified point of interest information to the point of interest server;

FIG. 7A is diagrammatic representation of a default point of interest data structure for storing default point of interest information in accordance with an embodiment;

FIG. 7B is diagrammatic representation of a user-specified point of interest data structure for storing user-specified point of interest information in accordance with an embodiment;

FIG. 8A is a diagrammatic representation of a point of interest option menu that may be transmitted to a mobile terminal upon establishment of a communication session between the mobile terminal and the point of interest server in accordance with an embodiment;

FIG. 8B is a diagrammatic representation of a point of interest menu that may be transmitted to a mobile terminal upon selection of a menu item from the menu depicted in FIG. 8A in accordance with an embodiment;

FIG. 9 is a flowchart depicting an embodiment of mobile terminal processing for obtaining user-specified point of interest location and/or navigation information; and

FIG. 10 is a flowchart depicting an embodiment of point of interest server processing that facilitates distribution of point of interest information.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Heretofore, no mechanism or system has been provided that allows for user-specified POI information to be provided in conjunction with a GPS location service. In accordance with embodiments, mechanisms for user supply of point of interests is provided. The user-supplied POI information may be maintained in a network storage facility e.g., in an Intenet-repository, in a mobile terminal, or other electronic digital storage device. A GPS device or application may then initiate a query of a user-supplied POI in conjunction with the GPS location of the GPS device. Location or navigation information of the user-supplied POI may be retrieved and transmitted to the GPS device for display thereby as described more fully hereinbelow.

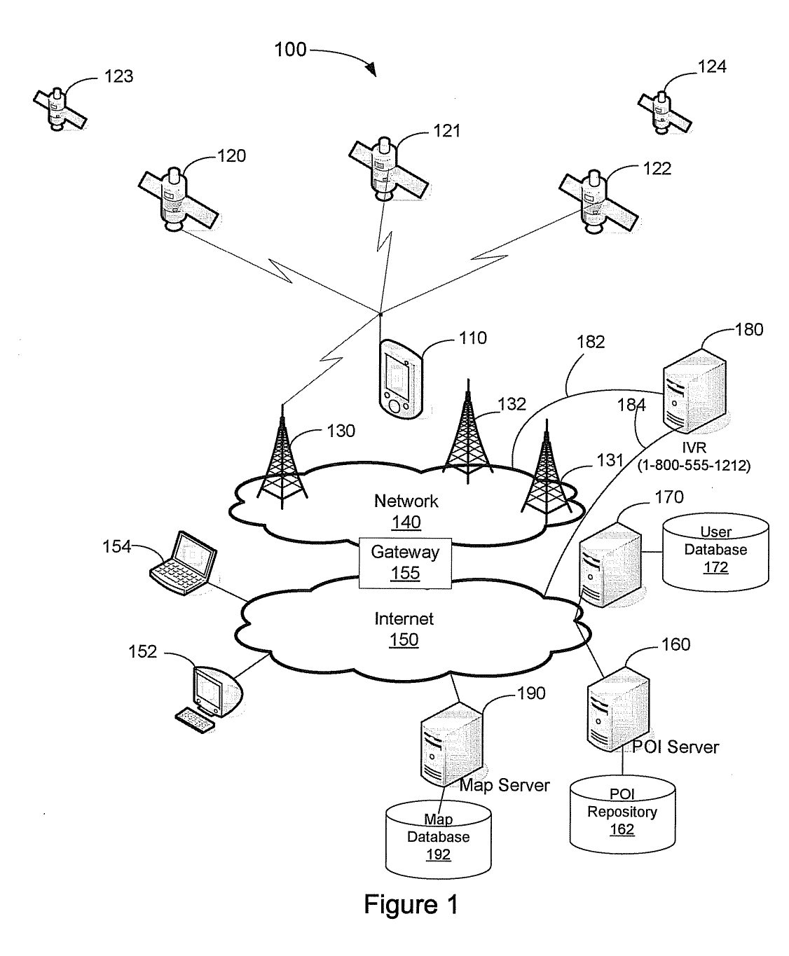

FIG. 1 is a diagrammatic representation of a network system 100 in which a mobile terminal 110 may be deployed for obtaining position and directional information in accordance with embodiments. System 100 may include a constellation comprising a plurality of GPS satellites 120-124 and a plurality of wireless transceivers 130-132 or other network towers and infrastructure. Mobile terminal 110 may feature a telemetric system comprising a positioning subsystem. To this end, mobile terminal 110 may include telephony, data delivery, navigation, status monitoring, and media features, and may be adapted to resolve positional information received either from GPS satellites 120-124 or wireless transceivers 130-132.

Satellites 120-124 may broadcast their position for reception by GPS receiver components included in mobile terminal 110. GPS signals originating from GPS satellites 120-124 include GPS data indicative of the position of satellites 120-124. GPS satellites 120-124 are representative of a functional satellite navigation system and may comprise a constellation of over two dozen satellites, and the depicted constellation of satellites 120-124 is provided for illustrative purposes only. System 100 may feature satellite radio system infrastructure, such as terrestrial-based repeaters, and the configuration depicted in FIG. 1 is illustrative only. The manner in which GPS satellites 120-124 communicate with ground-based and air-borne components is well known to those skilled in the art.

System 100 may include terrestrial-based transceivers 130-132 that may communicatively couple mobile terminal 110 with a network 140. In one implementation, network 140 may comprise a cellular telecommunication network, such as a Global System for Mobile Communications (GSM) networks, a 3^{rd} Generation Partnership Project (3GPP) compliant networks, a Universal Mobile Telecommunications System (UMTS), or another suitable network, and may feature an IP Multimedia Subsystem (IMS), Multimedia Messaging Service (MMS), or other suitable transport mechanisms. Transceivers 130-132 may comprise base transceiver stations adapted to transmit and receive data over an air interface, Accordingly, terminal 110 may comprise a cellular telephone with integrated or peripheral GPS functionality. In another embodiment, terminal 110 may be implemented as a transceiver deployed in an automobile navigation system and may communicate with network 140 infrastructure. Network 140 and transceivers 130-132 may also provide location information in conjunction with or without the GPS satellites 120-124.

In another embodiment, mobile terminal 110 may not include GPS-capable functions or circuitry. In this implementation, system 100 may be adapted for terrestrial-based location determination. For instance, triangulation algorithms may be deployed in network 140 for resolving the location of mobile terminal 110 by mechanisms known in the art. The mobile terminal location may be transmitted to mobile terminal 110 via an air interface established between one or more of transceivers 130-132. In other embodiments, the mobile terminal location may not necessarily be transmitted to mobile terminal 110 but rather may be maintained in a registry or other database, such as a home location register or visitor location register, within network 140.

Mobile terminal 110 may store map information for display thereof, and position information resolved from GPS location data received by mobile terminal 110 may be displayed on mobile terminal 110 in conjunction with map information. Alternatively, map information may be communicated to GPS receiver 100 from another entity such as a network-based service.

A network point of interest (POI) server 160 may be included in system 100. In the illustrative example, POI server 160 is deployed in Internet 150 that interfaces with network 140 via gateway 155. Server 160 may include or interface with a POI repository 162 that may maintain user-specified POI information as described more fully hereinbelow. To this end, server 160 may be implemented as a Hypertext Transfer Protocol (HTTP) server and may include or otherwise interface with an application server, such as application server 170, that facilitates provisioning of user-specified POI information in accordance with embodiments. Application server 170 may be adapted to facilitate configuration of user accounts, specification of default and user-specified POI information, and/or other account management functions. To this end, application server 170 may include or interface with a user database 172. User database 172 may include usernames, personal identification numbers (PINs), preference information, or other information of users subscribed or otherwise authorized to access the POI service. While POI server 160 and application server 170 are depicted as separate entities, POI server 160 and application server 170 may be deployed as a single data processing entity.

As is known, Internet 150 comprises a worldwide collection of networks, gateways, computers, and other infrastructure that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, other network configurations, such as an intranet, a local area network (LAN), or a wide area network (WAN), or the like may be suitably substituted for Internet 140.

System 100 may include a map server 190 or other location service that may provide location and navigation search services. To this end, map server 190 may include or interface with a map database 192. In general, map server 190 may receive a query that includes a GPS location, e.g., a longitude and latitude, and a destination location name, e.g., a business name, interrogate map database 192 with the GPS location and the destination location name, and provide location or navigation information that depicts, describes or otherwise defines a relative location or directional information from the GPS location to the destination location name. The location or navigation information may be transmitted to mobile terminal 110 for display thereby. In accordance with an embodiment, a destination location name used to query map server 190 may be selected or otherwise provided by a user of mobile terminal 110. Moreover, mobile terminal 110 may provide a menu of destination location names that have been previously supplied by the user. Thus, embodiments disclosed herein provide for transmission of location or navigation information of user-specified POIs as described more fully hereinbelow.

System 100 may include a data processing system 152 adapted to connect with Internet 150. In accordance with an embodiment, system 152 may be implemented as a personal computer, a laptop computer, a personal digital assistant, or other device with instruction execution capabilities and may connect with POI server 160 and/or application server 170. To this end, system 152 may be a client to server 160 or 170. In an embodiment, a user of system 152 may supply POI information to POI server 160 (or application server 170) that, in turn, stores the POI information in POI repository 162. The user may later access POI server 160 or application server 170 from a mobile terminal, e.g. mobile terminal 110, and POI server may transmit the user-supplied POIs, e.g., as a menu of selectable POIs, to the mobile terminal. The user may then select a user-specified POI to obtain location or navigation information thereof.

Additionally, a user may have multiple data processing systems deployed in system 100, and POI information may be accessed and provided to any one or more of the devices associated with the user. For example, a laptop computer 154 may be deployed in system 100 and may be associated with a user of mobile terminal 110. The user of laptop computer 154 may access POI information and obtain directions to POIs from laptop computer 154. In implementations where POI information is stored locally on the user device(s), POI information may be maintained by mobile terminal 110 and laptop 154, and changes thereto may be hot sync'd between the multiple devices. Of course, FIG. 1 is intended as an example, and not as an architectural limitation of a system in which embodiments disclosed herein may be implemented, and various other network system configuration may be suitably substituted therefor.

In one embodiment, user database 172 may include user specified information and/or user preference information regarding how the application will be used by the user, how often the POI database is updated, and what information the user desires to receive on terminal 110.

Application server 170 provides the computer logic that provides the user the requested/desired POI location information. Application server 170 may work in conjunction with the user database 172, Map Server 190, and POI server 160. Although POI server 160 and application server 170 are depicted and described as distinct nodes deployed in system 100, the functionality of servers 160 and 170 may be integrated into a single node.

In another embodiment, system 100 may additionally include an interactive voice response (IVR) system 180 adapted to perform voice-to-speech and speech-to-voice conversion. In this manner, system 100 may accommodate mobile terminals that do not feature browser or other data-delivery services and may provide POI services to voice-only terminals. For example, IVR system 180 may have a phone number (illustratively designated 1-800-555-1212) assigned thereto. A user of a mobile terminal may call the phone number of IVR system 180, and IVR system 180 may provide a voice prompt menu to the mobile terminal over a voice link 182. The user may speak a POI that is transmitted to IVR system 180 as speech (either encoded or non-encoded, e.g., PCM) over network 140, and IVR system 180 may in turn convert the spoken POI to text. The text-converted POI may then be used to interrogate map server 190 via an IP connection 184 or other data connection over Internet 150 that returns driving directions and optionally other supplementary information to IVR system 180 as text-based driving directions (and optionally text-based supplementary information). IVR system 180 may then convert the text-based driving directions to speech using a text-to-speech algorithm and may then transmit the driving directions as voice or audio signals to the mobile terminal. In this manner, system 100 may accommodate mobile terminals that do not have browser or other data capabilities.

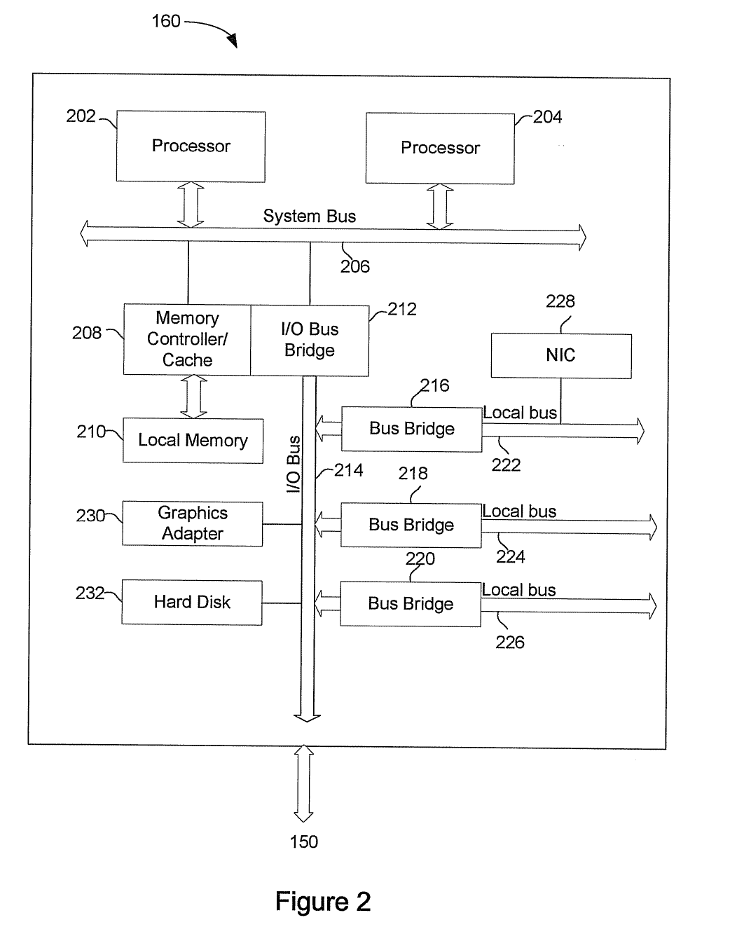

FIG. 2 is an exemplary diagrammatic representation of POI server 160 that may be configured for provisioning of user-specified POI information in accordance with embodiments disclosed herein.

Server 160 may be a symmetric multiprocessor (SMP) system that includes a plurality of processors 202 and 204 connected to a system bus 206 although other single-processor or multi-processor configurations may be suitably substituted therefor. A memory controller/cache 208 that provides an interface to local memory 210 may also be connected with system bus 206. An I/O bus bridge 212 may connect with system bus 206 and provide an interface to an I/O bus 214. Memory controller/cache 208 and I/O bus bridge 212 may be integrated into a common component.

A bus bridge 216, such as a Peripheral Component Interconnect (PCI) bus bridge, may connect with I/O bus 214 and provide an interface to a local bus 222, such as a PCI local bus. Communication links to other network nodes of system 100 in FIG. 1 may be provided through a network interface card (NIC) 228 connected to local bus 222 through add-in connectors. Additional bus bridges 218 and 220 may provide interfaces for additional local buses 224 and 226 from which peripheral or expansion devices may be supported. A graphics adapter 230 and hard disk 232 may also be connected to I/O bus 214 as depicted.

Those of ordinary skill in the art will appreciate that the hardware depicted in FIG. 2 may vary. The depicted example is not intended to imply architectural limitations with respect to implementations of the present disclosure.

Embodiments disclosed herein may be implemented as computer-executable instructions tangibly embodied on a computer-readable medium, such as local memory 210 or hard disk 232, that are run in conjunction with an operating system, such as a Unix operating system implemented as computer executable instructions executed by an instruction execution device, such as one or more of processors 202 and 204.

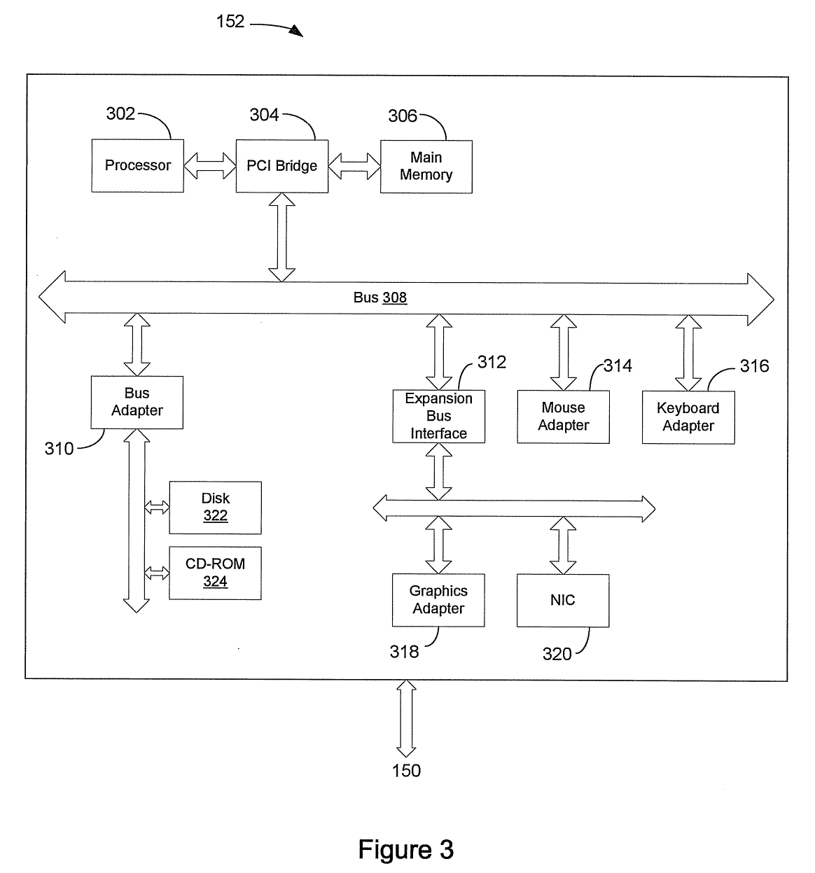

FIG. 3 is a diagrammatic representation of an exemplary embodiment of client data processing system 152 depicted in FIG. 1.

Code or instructions implementing client processes of embodiments disclosed herein may be located or accessed by client system 152 or transmitted thereto. In the illustrative example, client system 152 employs a PCI local bus architecture, although other bus architectures, such as the Industry Standard Architecture (ISA), may be used. A processor system 302 and a main memory 306 are connected to a PCI local bus 308 through a PCI bridge 304. PCI bridge 304 also may include an integrated memory controller and cache memory for processor system 302. Additional connections to PCI local bus 308 may be made through direct component interconnection or through add-in connectors. In the depicted example, a small computer system interface (SCSI) host bus adapter 310, an expansion bus interface 312, a mouse adapter 314, and a keyboard adapter 316 are connected to PCI local bus 308 by direct component connection. In contast, a graphics adapter 318 and a NIC 320 are connected to PCI local bus 308 via expansion bus interface 312 by add-in boards inserted into expansion slots. Expansion bus interface 312 provides a connection for various peripheral devices. NIC 320 provides an interface for connecting client system 300 with other devices in system 100 depicted in FIG. 1. SCSI host bus adapter 310 provides a connection for a hard disk drive 322, and a CD-ROM drive 324. Typical PCI local bus implementations may support a plurality of PCI expansion slots or add-in connectors.

An operating system runs on processor system 302 and is used to coordinate and provide control of various components within client system 300. Instructions for the operating system and applications or programs are located on storage devices, such as hard disk drive 322, and may be loaded into main memory 306 for execution by processor system 302.

In accordance with an embodiment, a user may supply POI information to server 160 that, in turn, stores the user-supplied POI information in POI repository 162. The user may supply POI information from a client station, such as system 152 or mobile terminal 110. A mobile terminal may then be used by the user to access the user-supplied POI information for obtaining location and navigation information of the user-supplied POI.

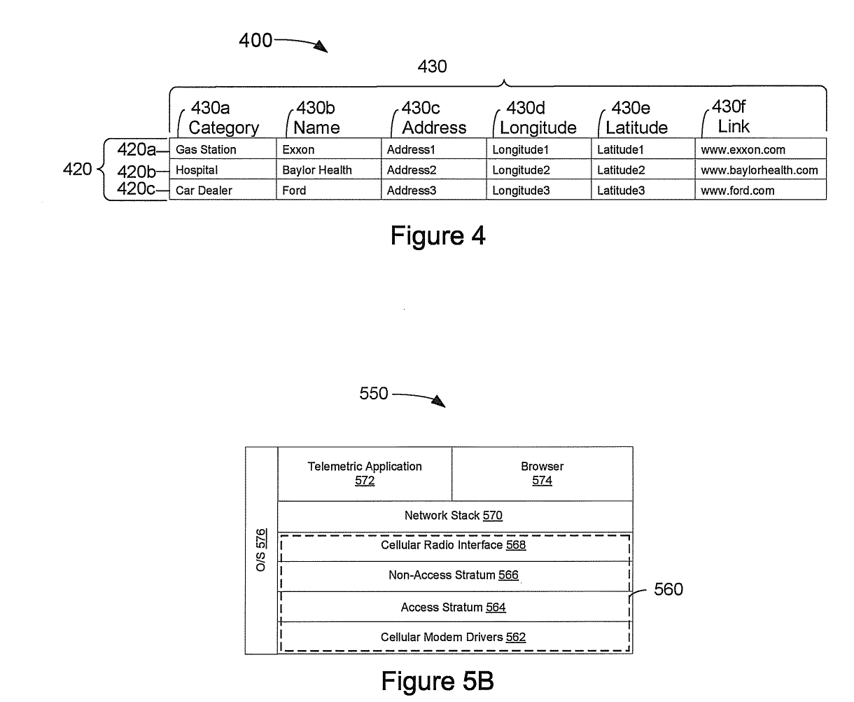

FIG. 4 is a diagrammatic representation of a map data structure 400 depicting three exemplary map records implemented in accordance with an embodiment. Map data structure 400 may be stored in map database 192 accessible by map server 190 depicted in FIG. 1. In the illustrative example, data structure 400 comprises a table although other data structures, such as a hierarchical tree or object collection, may be suitably substituted for data structure 400. Data structure 400 is depicted as a table only to facilitate an understanding of embodiments disclosed herein.

Data structure 400 comprises a plurality of records 420 and fields 430 that facilitate recordation of POI information and correlation of location information therewith. Data structure 400 may be stored on a storage device, such as a local memory or hard disk of map server 190, fetched therefrom by a processor, and processed by map server 190.

Each record 420a-420c, or row, comprises data elements in respective fields 430a-430f. Fields 430a-430f have a respective label, or identifier, that facilitates insertion, deletion, querying, or other data operations or manipulations of data structure 400. In the illustrative example, fields 430a-430f have respective labels of “Category”, “Name”, “Address”, “Longitude,” “Latitude,” and “Link.”

In the illustrative example, data elements stored in Category field 430a may comprise string data elements that identify a category of a POI specified by an associated record. For example, POI categories may include various business types or labels, such as gas stations, hospitals, car dealers, restaurants, or other POI classifications. In the present example, categories of “Gas Station,” “Hospital,” and “Car Dealer” are specified by Category field 430a of respective records 420a-420c. Name field 430b may maintain data elements that may specify a name of a POI specified by a respective record. In the present example, POI names of “Exxon,” “Baylor Health,” and “Ford” are specified by Name field 430b of respective records 420a-420c. Data elements stored in Address field 430c may comprise string data elements that specify an address of a POI specified by an associated record. In the present example, POI addresses of “Address1,” “Address2,” and “Address3” are specified for the POIs of respective records 420a-420c. Address1-Address3 are representative of physical geographic addresses and may include, for example, a street address, city, state, and zip code. To this end, data elements of Address field 430c may comprise a plurality of strings, e.g., comma-separated delimiter string values or other delimited values. Alternatively, address, city, state and zip code fields may be suitably substituted for Address field 430c. Data elements stored in Longitude field 430d and Latitude field 431e may comprise values that specify a respective longitude and latitude of POIs of records 420a-420c. In the illustrative example, longitude and latitude values of fields 430d-430e are illustratively designated as “Longitude1”-“Longitude3” and “Latitude1”-“Latitude3,” respectively. Link field 430f may contain data elements that may specify a network link or address to a network resource that may provide supplementary information related to the POI of the associated record 420a-420c. In the present example, links of “www.exxon.com,” “www.baylorhealth.com,” and “www.ford.com” are specified by Link field 430f of respective records 420a-420c and are representative of respective uniform resource locators (URLs) associated with the POI of respective records 420a-420c or other addresses associated with other data sources or repositories. For example, the link “www.exxon.com” may comprise a URL of a website hosted by Exxon. In other implementations, the links of link field 430f may contain links to a database or other resource of similar or related POIs, to a link list, or other resource that may facilitate delivery of supplementary information. Other fields may be included in records 420a-420c for providing additional supplementary information related to the POIs, e.g., to information resources offering discounted goods at the associated POI or other related POIs, product service descriptions, RSS feeds, Podcasts, or other media. Various other supplementary information may be accommodated by records 420a-420c in addition to those described.

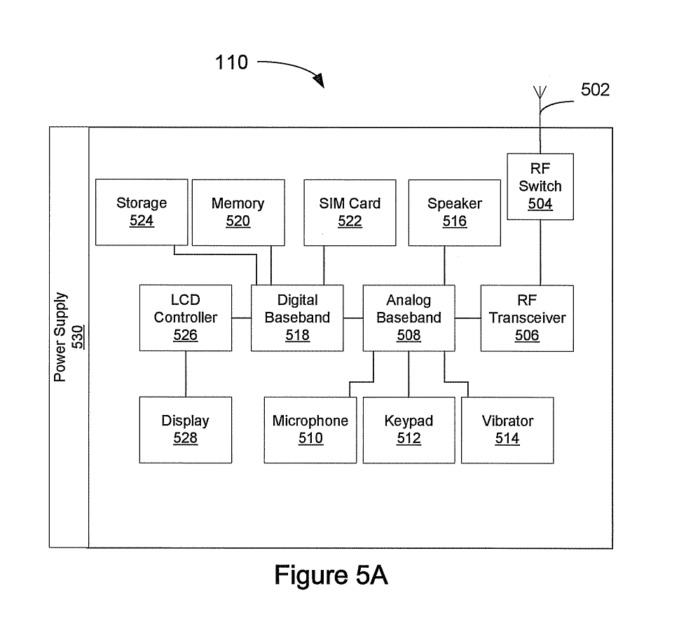

FIG. 5A is a simplified block diagram of an exemplary mobile terminal 110 in which embodiments may be implemented. Mobile terminal 110 includes an antenna 502 that may be coupled with an RE switch 504, e.g., a duplexer, coupled with an RF transceiver 506. Transceiver 506 may be coupled with an analog baseband 508 that may handle a variety of analog signal processing functions. In the present example, analog baseband 508 is interconnected with a microphone 510, a keypad 512, a vibrator 514 or other ring alert mechanism, and a speaker 516. Analog baseband 508 may include or interface with an analog to digital converter for converting analog input supplied to microphone 510 into a digital format that may be supplied to a digital baseband 518. Digital baseband 518 may interface with various digital components of mobile terminal 110, such as a memory 520, subscriber identity module (SIM) 522, and a liquid crystal display controller 526 that drives a display 528. Memory 520 may be implemented as a flash memory, a random access memory, an electronically erasable programmable read-only memory, another solid state device, or a combination thereof. In other implementations, mobile terminal 110 may include, in addition to memory 520 or in lieu thereof, a storage device 524, such as a hard drive. Digital baseband 518 may additionally include or interface with one or more encoders, digital to analog converters, or other modules. A power supply 530 may be coupled with various system modules as is understood.

FIG. 5B is a diagrammatic representation of an exemplary software configuration 550 of mobile terminal 110 adapted to request and receive location and navigation information in system 100 depicted in FIG. 1 in accordance with an embodiment. In the exemplary configuration of FIG. 5B, the mobile terminal is configured with access network-specific software entities 560, e.g., protocol and driver software associated with a particular access network technology, such as GSM, UMTS, or another suitable radio access network, and is dependent on the particular cellular network in which the mobile terminal is to be deployed. While configuration 550 depicts a mobile terminal adapted for deployment in a single access network technology type, the mobile terminal may be implemented as a multi-mode device and may accordingly include a plurality of access-specific entities. The particular configuration 550 is illustrative only and is provided only to facilitate an understanding of embodiments disclosed herein.

In the illustrative example, configuration 550 includes a cellular modem driver 562 for providing a physical interface with the access network in which the mobile terminal is deployed. An access-stratum 564 and a non-access stratum 566 may be included in configuration 550. A cellular radio interface 568 may be communicatively coupled with lower layers of configuration 550 and may additionally interface with network and session management layers, e.g., a network stack 570 such as a TCP/IP.

Configuration 550 may optionally include a telemetric application 572 for resolving a geographic position from GPS location signals received from GPS satellites, such as satellites 120-124. In other implementations, configuration 550 may exclude telemetric application 572 and network system 100 may instead be adapted to resolve a location of mobile terminal 110. Configuration 550 may include a browser 574 adapted to transmit and receive communications in network system 100. Additionally, configuration 550 may include an operating system 576, such as Linux, Symbian, or another operating system suitable for mobile applications, and may coordinate and provide control of various components within the mobile terminal.

In one implementation, a user of mobile terminal 110 may establish a communication session with POI server 160, e.g., by entry of a uniform resource location (URL) or other suitable address of POI server into browser 574. POI server 160 may authenticate the user of mobile terminal 110 and thereafter transmit a POI menu to mobile terminal 110. In accordance with an embodiment, a POI menu transmitted to mobile terminal 110 may comprise user-specified POIs. The user of mobile terminal 110 may then select a POI, and the selected POI may be transmitted to POI server 160 along with location information of mobile terminal 110. POI server 160 may then interrogate map server 190 with the selected POI supplied as a destination location name and the location information of mobile terminal. On receipt of location or navigation information from map server 190 by POI sever 160, POI server 160 may transmit the location or navigation information to mobile terminal 110 where it may be displayed in browser 574.

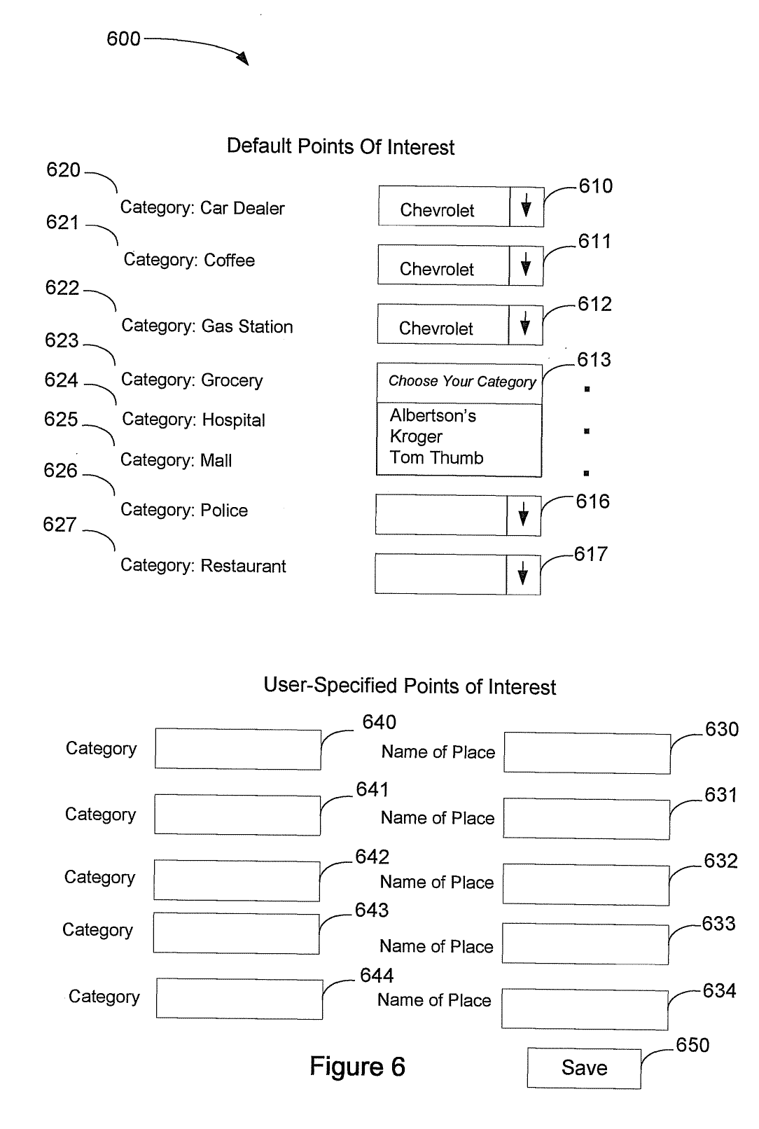

FIG. 6 is a diagrammatic representation of an embodiment of a web page 600 that may be provided by POI server 160 to a client thereof, such as client system 152, for submission of user-specified POI information to POI server 160. Web page 600 facilitates collection of user-specified POIs and distribution of location or navigation information thereof to users of mobile terminals. Page 600 may be implemented as a web page, such as an HTML document, a page produced by an applet, or another data structure suitable for network transmission to a client and viewing by a user thereof.

In the illustrative example, page 600 includes various fields and controls in which a user at a client station may select default POIs and enter user-specified POIs in accordance with embodiments. In the particular example, page 600 includes controls 610-617 comprising drop-down controls for selection of respective default POIs. Default POIs may be specified by a service provider, such as a POI provider having POI server 160 deployed in system 100. Each of the available default POIs may have a category specified therefor as indicated by control labels 620-627. In the illustrative example, controls 610-617 provide for user selection of default POI categories of Car Dealer, Coffee, Gas Station, Grocery, Hospital, Mail, Police, and Restaurant.

Additionally, page 600 may include one or more fields 630-634 for input of user-supplied POI names. Page 600 may also include fields 640-644 respectively associated with fields 630-634 for entry of categories of the user-specified POIs. In this manner, a user may enter the name of a POI, such as a business or location, that may or may not be included as a default POI. The user-selected default POIs and user-specified POIs may then be stored, e.g., in POI repository 162, in association with an identifier of the user, such as a user name, phone number of mobile terminal 10 associated with the user, an IMSI of the mobile terminal associated with the user, or another suitable identifier. User-selected default POIs and user-specified POIs may be stored, for example, in a relational database, SQL database, table, or other suitable data structure, in POI repository 162. Page 650 may include a Save control 650 that, in response to selection thereof by the user, results in POI server 160 saving the user-selected POIs and user-specified POIs in POI repository 162.

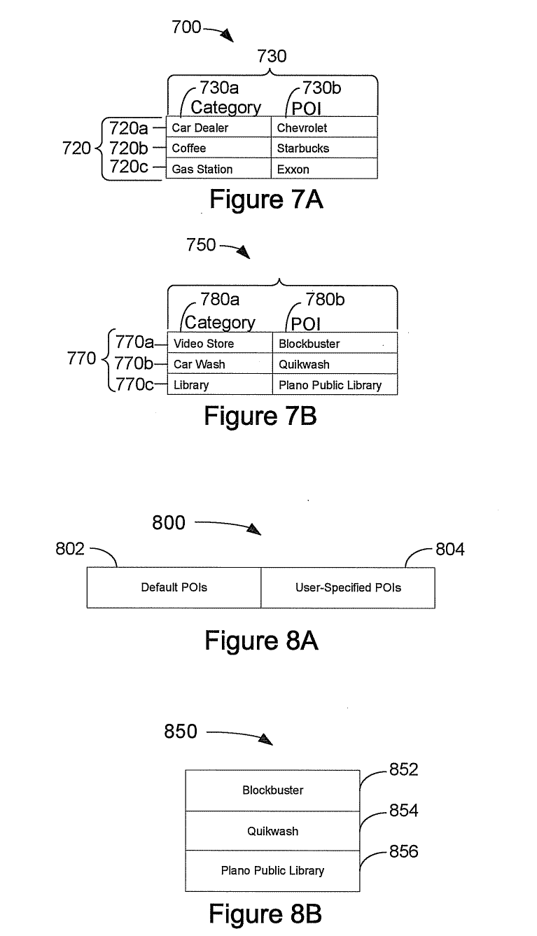

FIG. 7A is diagrammatic representation of a default POI data structure 700 for storing default POI information in accordance with an embodiment. POI data structure 700 may be stored in POI repository 162 accessible by POI server 160 depicted in FIG. 1. In the illustrative example, data structure 700 comprises a table although other data structures, such as a hierarchical tree or object collection, may be suitably substituted for data structure 700. Data structure 700 is depicted as a table only to facilitate an understanding of embodiments disclosed herein.

Data structure 700 comprises a plurality of records 720 and fields 730 that facilitate recordation of user-selected default POI information. For example, user-selected default POI information selected from one or more of default controls 610-617 of web page 600 and associated category information thereof may be stored in data structure 700.

Each record 720a-720c comprises data elements in respective fields 730a-730b. Fields 730a-730b have a respective label, or identifier, that facilitates insertion, deletion, querying, or other data operations or manipulations of data structure 700. In the illustrative example, fields 730a-730b have respective labels of “Category” and “POI.”

In the illustrative example, data elements stores in Category field 730a may comprise string data elements that identify a category of a POI specified by an associated record. In the present example, categories of “Car Dealer,” “Coffee,” and “Gas Station” are specified by Category field 730a of respective records 720a-720c. POI field 730b maintains data elements that may specify a name of a POI specified by a respective record. In the present example, POI names of “Chevrolet,” “Starbucks,” and “Exxon” are specified by POI field 730b of respective records 720a-720c. Thus, default data structure 700 facilitates storage of user-selected default POI information selected by a user from web page 600 or by another suitable mechanism.

FIG. 7B is diagrammatic representation of a user-specified POI data structure 750 for storing user-specified POI information in accordance with an embodiment. POI data structure 750 may be stored in POI repository 162 accessible by POI server 160 depicted in FIG. 1. In the illustrative example, data structure 750 comprises a table although other data structures, such as a hierarchical tree or object collection, may be suitably substituted for data structure 750. Data structure 750 is depicted as a table only to facilitate an understanding of embodiments disclosed herein.

Data structure 750 comprises a plurality of records 770 and fields 780 that facilitate recordation of user-specified POI information. For example, user-specified POI information supplied to one or more of fields 630-634 and categories supplied to one or more of associated fields 640-644 of web page 600 may be stored in data structure 750.

Each record 770a-770c comprises data elements in respective fields 780a-780b. Fields 780a-780b have a respective label, or identifier, that facilitates insertion, deletion, querying, or other data operations or manipulations of data structure 750. In the illustrative example, fields 780a-780b have respective labels of “Category” and “POI.”

In the illustrative example, data elements stored in Category field 780a may comprise string data elements that identify a category of a POI specified by and associated record. In the present example, categories of “Video Store” “Car Wash,” and “Library” are specified by Category field 780a of respective records 770a-770c. POI field 780b maintains data elements that may specify a name of a POI specified by a respective record. In the present example, POI names of “Blockbuster,” “Quikwash,” and “Plano Public Library” are specified by POI field 780b of respective records 770a-770c. Thus, user-specified data structure 750 facilitates storage of user-specified POI information supplied by a user to web page 600 or by another suitable mechanism.

In another embodiment, POI information, such as default POI data structure 700 and user-specified data structure 750, may be maintained locally on mobile terminal 110 and/or laptop computer 154. For example, data structures 700 and 750 may be maintained in memory 520 or storage 524 of mobile terminal 110 depicted in FIG. 5. In other implementations, functionality, at least in part, of POI server 160 may be deployed on mobile terminal 110 as executable instructions processable by digital baseband 518 or another processing device of mobile terminal 110. In this implementation, POI information may be retrieved from memory 520 or storage 524, provided on display 528 for user selection or specification of a POI by the user of mobile terminal 110, and mobile terminal 110 may then issue a query of map server 190 directly without involvement of a POI server.

In embodiments where POI information is accessed by a laptop computer or personal computer, location information such as a GPS location, of the device may not be available. In this instance, the user may provide a location of the device, e.g., as a starting position. Upon specification of a POI, the location information specified by the user may be transmitted with the specified POI for generating a location query as described above. A default starting location may also be specified, such as an address of the user's home, work, or other default location. The system may also allow the user to enter a new starting location for a particular query.

FIG. 8A is a diagrammatic representation of a POI option menu 800 that may be transmitted to mobile terminal 110 upon establishment of a communication session between mobile terminal 110 and POI server 160 in accordance with an embodiment. In the present example, menu 800 comprises menu items 802 and 804 or other user-selectable controls that provide a mechanism for the user to specify the type of location or navigation information the user is interested in obtaining. In the present example, menu item 802 has a label of Default POIs and menu item 804 has a label of User-Specified POI. In the event that the user selects Default POIs menu item 802, a selection message may be transmitted from browser 574 hosted by mobile terminal 110 to POI server 160 that indicates the selection of Default POIs menu item 802. In response to receipt of the selection message, POI server 160 may interrogate POI repository 162 to obtain the default POIs configured for the user. The retrieved default POIs may then be transmitted to mobile terminal 110 configured as a menu of user-selected default POIs. On selection of a default POI from the menu, the name of the selected POI and GPS location information of the mobile terminal may be transmitted to POI server 160 that, in turn, queries map server 192. On receipt of location or navigation information of the selected POI by POI server 160, POI server 160 may transmit the POI location or navigation information to mobile terminal 110.

In a similar manner, if the user selects User-Specified POIs menu item 804, a selection message may be transmitted from browser 574 hosted by mobile terminal 110 to POI server 160 that indicates the selection of User-Specified POIs menu item 804. In response to receipt of the selection message, POI server 160 may interrogate POI repository 162 to obtain the user-specified POIs configured for the user. The retrieved user-specified POIs may then be transmitted to mobile terminal 110 configured as a menu of user-specified POIs. On selection of a user-specified POI from the menu, the name of the selected POI and GPS location information of the mobile terminal may be transmitted to POI server 160 that, in turn, queries map server 192. On receipt of location or navigation information of the selected POI by POI server 160, POI server 160 may transmit the POI location or navigation information to mobile terminal 110.

Assume the user selects User-Specified menu item 804. Mobile terminal 110 may then send a menu selection message to POI server that indicates the user has selected the User-Specified menu item. On receipt of the menu selection message, POI server 160 may interrogate POI repository 162 to retrieve each of the user-specified POIs. POI server may generate a POI menu that includes menu items each corresponding to one of the user-specified POIs. FIG. 8B is a diagrammatic representation of a POI menu 850 that may be transmitted to mobile terminal 110 upon selection of a menu item 804 from menu 800 in accordance with an embodiment. In the present example, menu 850 comprises menu items 852-856 or other user-selectable controls that provide a mechanism for the user to select a particular POI for location or navigation information the user is interested in obtaining. In the present example, menu item 852 has a label of Blockbuster, menu item 854 has a label of Quikwash, and menu item 856 has a label of Plano Public Library.

Assume the user selects menu item 852. A POI selection message may be transmitted from browser 574 hosted by mobile terminal 110 to POI server 160 that indicates the selection of POIs menu item 852. That is, the POI selection message includes an indication of selection of the Blockbuster POI. Additionally, the POI selection message may include a GPS location of mobile terminal 110. In response to receipt of the POI selection message, POI server 160 may query map server 190 with the POI name “Blockbuster” and the mobile terminal's GPS location. Map server 190 may, in turn, query map database 192, obtain location or navigation information related to the POI, and return the location or navigation information to POI server 160. POI server 160 may then transmit the location or navigation information to terminal 110 for display thereby.

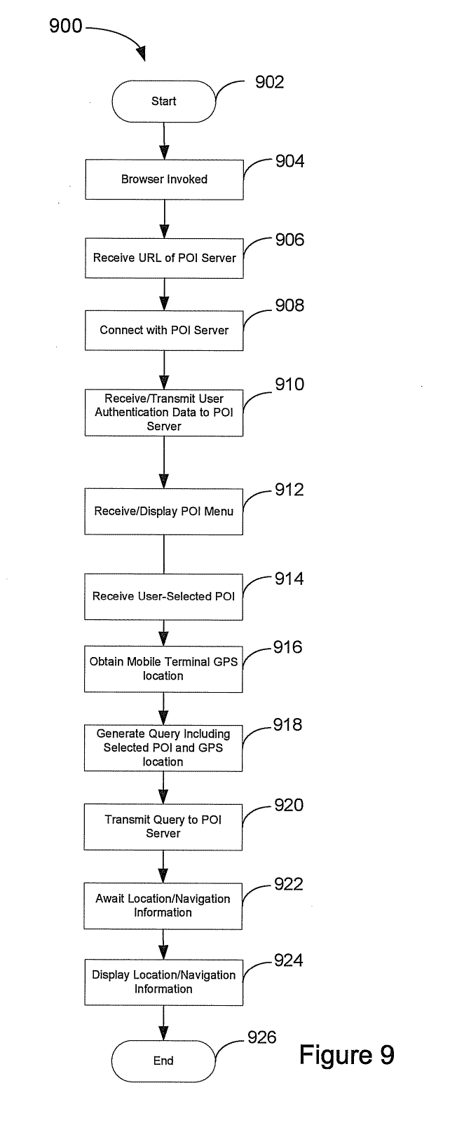

FIG. 9 is a flowchart depicting an embodiment of mobile terminal processing for obtaining user-specified POI location and/or navigation information. Mobile terminal processing is started (step 902), and a browser or other suitable application is invoked (step 904). The URL or other suitable address of the POI server is input by the mobile terminal user (step 906), and a connection with the POI server is then established (step 908). The mobile terminal may then receive a prompt for user authentication data, e.g., a user name and password, and upon supply thereof by the user, the authentication data is transmitted to the POI server (step 910). A POI menu may then be received by the mobile terminal from the POI server and output on a display device of the mobile terminal (step 912). A user-selected POI is then received by the mobile terminal (step 914), and the mobile terminal then obtains a GPS location of the mobile terminal (step 916). The mobile terminal then generates a query or POI selection message that includes the user-selected POI and the mobile terminal GPS location (step 918), and the query is then transmitted to the POI server (step 920). The mobile terminal then awaits location/navigation information of the POI (step 922), and on receipt thereof displays the location/navigation information (step 924). In another embodiment, a map that includes a graphical depiction of the mobile terminal location and the POI may be transmitted to the mobile terminal for display thereby. In another embodiment, location or navigation information of a plurality of POIs may be transmitted for display by the mobile terminal. In still another embodiment, a map including a graphical depiction of the mobile terminal location and a respective graphical depiction of a predefined number of the nearest POIs may be transmitted to the mobile terminal. The mobile terminal location/navigation processing cycle may then end (step 926).

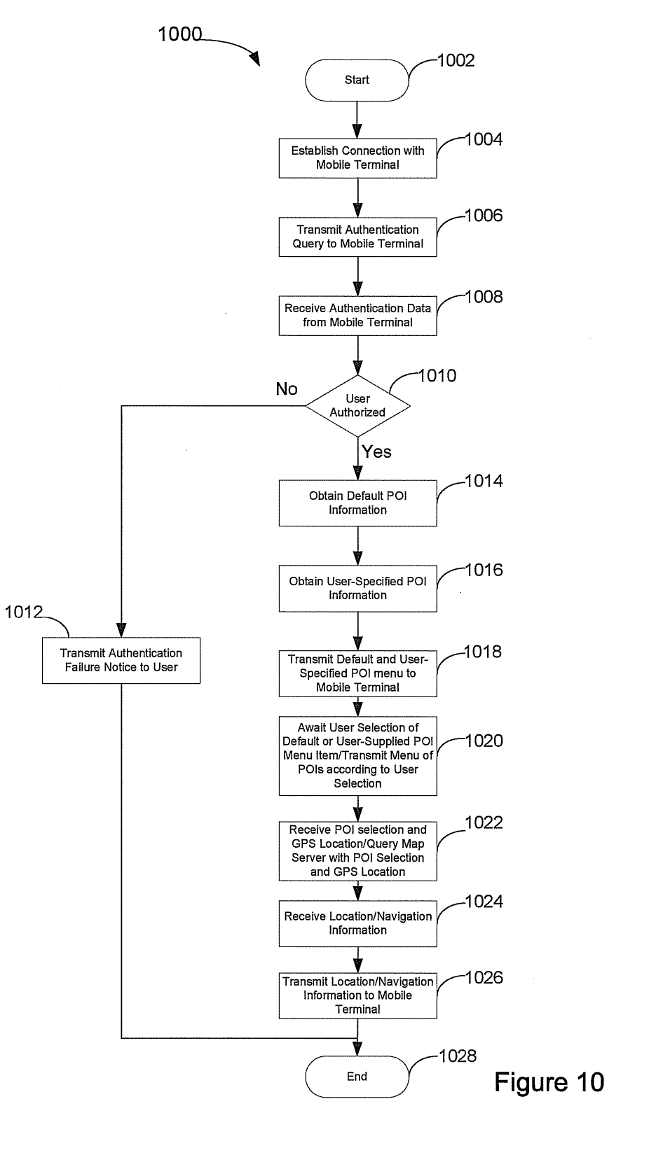

FIG. 10 is a flowchart depicting an embodiment of POI server processing that facilitates distribution of POI information. The POI server processing routine is invoked (step 1002), and a connection with a mobile terminal is established (step 1004). An authentication query may be transmitted to the mobile terminal (step 1006), e.g., a prompt for a user name and password. The POI server then awaits receipt of the authentication data (step 1008), and an evaluation may be made to determine if the user is authorized (step 1010). If the user is not authorized, an authentication failure notice may be transmitted to the mobile terminal (step 1012), and the POI server processing routine cycle may then exit (step 1028).

In the event the user is successfully authenticated at step 1010, the POI server may then obtain default POI information (step 1014) and user specified POI information (step 1016) for the user. A default and user-specified POI menu similar to that depicted in FIG. 8A may then be transmitted to the mobile terminal (step 1018). The POI server may then await user selection of either the default POI information or user-specified POI information, and may then transmit a menu of default POIs or user-specified POIs to the mobile terminal accordingly (step 1020). The POI server may then await receipt of a user POT selection and GPS location information (step 1020) and, on receipt thereof, the POI server may then query the map server with the selected POI and the GPS location information of the mobile terminal (step 1022). The POI server then receives location/navigation information related to the POI (step 1024). The location/navigation (e.g., directional, map, or other content) information may include location or navigation information of the nearest POI matching the selected POI or may alternatively include location or navigation information of a predefined number, e.g., 5, matching POIs that are nearest to the mobile terminal. The location and/or navigation information may then be transmitted to the mobile terminal (step 1026). The POI server processing cycle may then end according to step 1028.

In another embodiment, a user may select a generic POI request in which only the location or a default location are transmitted for a POI query. In this implementation, POI server 1601 may be adapted to resolve a predefined number, such as 5 POIs, that are closest to the mobile terminal or default location. In this embodiment, a map may be generated, either by POI server and/or map server 190, that includes a graphical depiction of the mobile terminal location or the default location along with graphical depictions of the closest POIs, e.g., 5 of the POIs nearest the mobile terminal location or default location.

As described, mechanisms are provided for receiving and storing user-selected and user-specified points of interest. The user may then access the stored points of interest from a mobile device. A location of the mobile terminal may be obtained, e.g., through GPS functions or a terrestrial-based location service. A user may select a POI for issuing a location or navigation query. The mobile terminal location along with the selected POI may then be used for interrogating a map service or other location service. Location or navigation information may then be communicated to the mobile terminal for display thereby.

User-specified POIs may be configured as a network-accessible “Favorite Places” menu that is accessible via a mobile device anywhere the mobile device is in communication with a network service. Advantageously, a user may obtain direction or navigation information of places of interest in a convenient and mobile manner.

In other embodiments, a user can share their favorite locations or user-supplied POIs, including place location information, with their fiends, family, and communities of interest by sending an e-mail, Short Message Service (SMS), Instant Message (IM), or other text transfer mechanisms. In such a community, a user may also pass on advertising, reviews, comments, URL links, ratings, photo's, video's of the POI to members of the community.

In other embodiments, a user may enter, for example via a menu option, a description to search. The description may be a product description, product unique ID number, or any other description of products and services. The application server in conjunction with the Map database and search engine may search for POI that are associated with the description. The user may be presented with POIs that are closest to the terminal that closely match the description. Data presented to the user may comprise, but are not limited to, description, reviews, price, and advertising.

In other embodiments, a user may select via menu options presented to the user the desire to receive information from either/or both the category and/or the POI. This information can be advertising, continuous streaming feed—such as blogs, RSS feeds, Podcasts, digital images (both photo's and videos), textual information, or other media.

The flowcharts of FIGS. 9 and 10 depict process serialization to facilitate an understanding of disclosed embodiments and are not necessarily indicative of the serialization of the operations being performed. In various embodiments, the processing steps described in FIGS. 9 and 10 may be performed in varying order, and one or more depicted steps may be performed in parallel with other steps. Additionally, execution of some processing steps of FIGS. 9 and 10 may be excluded without departing from embodiments disclosed herein. The illustrative block diagrams and flowcharts depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like.

Aspects of the present invention may be implemented in software, hardware, firmware, or a combination thereof. The various elements of the system, either individually or in combination, may be implemented as a computer program product tangibly embodied in a machine-readable storage device for execution by a processing unit. Various steps of embodiments of the invention may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying the aspects of the present invention can be loaded onto a computer. The computer program is not limited to any particular embodiments, and may, for example, be implemented in an operating system, application program, foreground or background process, driver, network, stack, or any combination thereof, executing on a single computer processor or multiple computer processors. Additionally, various steps of embodiments of the invention may provided one or more data structures generated, produced, received, or otherwise implemented on a computer-readable medium, such as a memory.

Although embodiments of the present disclosure have been described in detail, those skilled in the art should understand that they may make various changes, substitutions and alternations herein without departing from the spirit and scope of the present disclosure.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims,

What is claimed is:

1. A method of distributing location information regarding a point of interest, comprising:
storing a name of a point of interest;
receiving a request for location information regarding the point of interest;
receiving location information associated with a device that issued the request;
querying a location service with a name of the point of interest and the location; and
transmitting location information regarding the point of interest to the device.

2. The method of claim 1, wherein the device comprises a mobile terminal.

3. The method of claim 1, wherein storing further comprises:
accessing a server by a client system; and
transmitting a name of the point of interest from the client to the server, wherein the name is stored by the server,

4. The method of claim 3, wherein a user of the client system is associated with the device.

5. The method of claim 3, wherein transmitting a name further comprises supplying the name to a web page received by the client system from the server.

6. The method of claim 3, herein transmitting a name further comprises supplying the name via a transmission medium selected from the group consisting of a short message service, a text transmission, and voice input using speech-to-text conversion.

7. The method of claim 3 wherein transmitting a name further comprises selecting the name from a set of default names included in a data structure selected from the group consisting of a web page, short message service, or text medium received by the client system from the server.

8. The method of claim 1, wherein transmitting further comprises transmitting supplementary information.

9. The method of claim 1, further comprising transmitting to the device supplementary information selected from the group consisting of product information associated with the point of interest, service information associated with the point of interest, a uniform resource locator associated with the point of interest, a review associated with the point of interest, comments associated with the point of interest, advertisement content associated with the point of interest, a photo associated with the point of interest, and a video associated with the point of interest.

10. The method of claim 1, wherein receiving the request further comprise receiving a voice signal specifying the point of interest, the method further comprising converting the voice signal to text with a speech-to-text algorithm, wherein the name used to query the location service comprises text output from the speech-to-text algorithm.

11. The method of claim 10, further comprising:
receiving the location information as text-based directions by an interactive voice response system; and
converting the location information to speech using a text-to-speech algorithm, wherein transmitting location information comprises transmitting voice output of the text-to-speech algorithm.

12. A computer-readable medium having computer-executable instructions for execution by a processing system, the computer-executable instructions for distributing location information regarding a point of interest, comprising:
instructions that store a name of a point of interest;
instructions that receive a request for location information regarding the point of interest;
instructions that receive location information associated with a device that issued the request;
instructions that query a location service with a name of the point of interest and the location; and
instructions that transmit location information regarding the point of interest to the device.

13. The computer-readable medium of claim 12, wherein the device comprises a mobile terminal.

14. The computer-readable medium, of claim 12, wherein the instructions that store further comprise:
instructions that access a server by a client system; and
instructions that transmit a name of the point of interest from the client to the server, wherein the name is stored by the server.

15. The computer-readable medium of claim 14, wherein a user of the client system is associated with the device.

16. The computer-readable medium of claim 14, wherein the instructions that transmit a name further comprise instructions that supply the name to a web page received by the client system from the server.

17. The computer-readable medium of claim 14, wherein the instructions that transmit a name further comprise instructions that supply the name via a transmission medium selected from the group consisting of a short message service, a text transmission, and voice input using speech-to-text conversion.

18. The computer-readable medium of claim 14, wherein the instructions that transmit a name further comprise instructions that select the name from a set of default names included in a data structure selected from the group consisting of a web page, short message service, or text medium received by the client system from the server.

19. The computer-readable medium of claim 12, wherein the instructions that transmit further comprise instructions that transmit supplementary information.

20. The computer-readable medium of claim 12, further comprising instructions that transmit to the device supplementary information selected from the group consisting of product information associated with the point of interest, service information associated with the point of interest, a uniform resource locator associated with the point of interest, a review associated with the point of interest, comments associated with the point of interest, advertisement content associated with the point of interest, a photo associated with the point of interest, and a video associated with the point of interest.

21. A network system for implementing the methods of claims 1-11.
